(19) United States
(12) Patent Application Publication
(10) Pub. No.: US 2007/0164720 A1
(43) Pub. Date: Jul. 19, 2007

(54) Switch-mode power supply controllers

(76) Inventors: Vinod A. Lalithambika, Cambridge (GB); David Robert Coulson, Cambridge (GB); Jayaraman Kumar, Cambridge (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/641,229

(22) Filed: Dec. 19, 2006

Related U.S. Application Data
(60) Provisional application No. 60/756,507, filed on Jan. 5, 2006.

(30) Foreign Application Priority Data
Dec. 22, 2005 (GB) 0526118.5
Jul. 28, 2006 (GB) 0615029.6

(51) Int. Cl. G05F 1/00

(52) U.S. Cl. 323/288

(57) ABSTRACT

This invention relates to Switch Mode Power Supply (SMPS) controllers, especially analogue controllers employing a combination of Pulse Width Modulation (PWM) and Pulse Frequency Modulation (PFM). We describe a switch mode power supply (SMPS) controller circuit for controlling a power switching device of said SMPS, the circuit including: a current input to receive a feedback signal current dependent upon an output voltage of said SMPS; a ramp generator circuit coupled to said current control input to generate responsive to said feedback current signal consecutive first and second voltage ramps, one rising the other falling; and a control output responsive to said voltage ramps from said voltage ramp generator to provide a drive signal for controlling said power switching device.

### CROSS-REFERENCE TO RELATED APPLICATIONS

This application claims priority to United Kingdom Patent Application No. 0526118.5, filed Dec. 22, 2005 and to United Kingdom Patent Application No. 0615029.6, filed Jul. 28, 2006, each of which is incorporated in its entirety by reference herein. This application also claims the benefit of U.S. Provisional Patent Application No. 60/756,507, filed Jan. 5, 2006, which is incorporated in its entirety by reference herein.

### BACKGROUND OF THE INVENTION

1. Field of the Invention

This invention relates to Switch Mode Power Supply (SMPS) controllers, especially analogue controllers employing a combination of Pulse Width Modulation (PWM) and Pulse Frequency Modulation (PFM).

2. Description of the Related Art

Examples of SMPS controllers employing a combination of PFM and PWM control are described in US2005/0052249 and in JP2004/236461. Further background prior art can be found in US2005/270008; DE19515210; JP2004/236461; U.S. Pat. No. 5,568,044; and EP1 213 822A. However, there remains a general need for SMPS controller designs which operate across a wide variety of application architectures, operating modes, input conditions and output load conditions.

### SUMMARY OF THE INVENTION

According to a first aspect of the invention there is therefore provided a switch mode power supply (SMPS) controller circuit for controlling a power switching device of said SMPS, the circuit comprising: a current input to receive a feedback signal current dependent upon an output voltage of said SMPS; a ramp generator circuit coupled to said current control input to generate responsive to said feedback current signal consecutive first and second voltage ramps, one rising the other falling; and a control output responsive to said voltage ramps from said voltage ramp generator to provide a drive signal for controlling said power switching device.

In embodiments the feedback signal current may be either a positive or negative current and may, for example, be taken directly or indirectly from the output of an opto-isolator providing feedback from the output side of the SMPS power supply. In alternative arrangements, however, alternative techniques may be used to derive the feedback signal current including, but not limited to, a pulse transformer, and an additionally or auxiliary winding of an energy transfer inductor or transformer of the SMPS.

This may be implemented, for example, by imposing an initial voltage proportional to the feedback signal current on a capacitor forming part of the ramp generator circuit which is charged and discharged to create the first and second voltage ramps. Preferably the first voltage ramp has a substantially constant slope, that is a slope which is substantially independent of the feedback signal current. However, in preferred embodiments the second voltage ramp has a slope which varies in proportion to the feedback signal current.

Preferably the drive signal controlling the power switching device is substantially rectangular with an “on” period (in which the power switching device is to be turned on) and an “off” period (in which the power switching device is to be turned off). The first and second voltage ramps may be converted to such a drive signal by comparison with one or more reference voltage levels. Preferably the duration of the first voltage ramp (following initialisation) determines duration of the power device on period and the duration of the second voltage ramp determines the duration of the power device off period. The first and second voltage preferably, therefore, extend between first and second voltage levels, when the first voltage ramp initialisation voltage is taken into account (this providing an initial step for the first ramp). In some preferred embodiments the first ramp comprises a voltage which rises in magnitude and the second ramp comprises a voltage which falls in magnitude (although the skilled person will appreciate that the sign of the rising and falling voltages may be either positive or negative).

Preferably the SMPS controller includes a system to limit a slope of the second voltage ramp, more particularly to limit the slope so that it is not less than a minimum slope. In this way the maximum duration of the second (off) period of the drive signal may be limited, and this in turn limits the minimum switching frequency of the SMPS controller circuit. Preferably the minimum switching frequency is greater than a human-audible audio frequency, for example greater than 10 KHz, 15 KHz or 20 KHz. Thus preferably the maximum duration of the off period of the drive signal is no more than 0.1 ms or, more preferably 0.05 ms (corresponding to a minimum switching frequency of greater than 20 KHz).

In some preferred embodiments the controller also includes a slope compensation system to adjust a slope of the second voltage ramp in response to a sensed condition of the SMPS, in particular a current through the power switching device.

In some particular preferred embodiments the SMPS controller circuit is implemented in MOS (Metal Oxide Semiconductor) technology, in particular CMOS (Complementary MOS) technology. Thus the current control input preferably divides an input to a current mirror circuit which is used to mirror the feedback signal current for controlling the ramp generator circuit. The ramp generator circuit preferably includes a capacitor which is charged and discharged to generate the first and second voltage ramps. Preferably it further comprises a substantially fixed constant current generator (either a current source or a current sink) and controllable constant current generator (one used for charging the capacitor, the other for discharging the capacitor). Preferably the constant current generator is used to charge the capacitor to generate the first voltage ramp and the controllable constant current generator is used to discharge the capacitor to provide a second voltage ramp with a controllable slope. The slope of the second voltage ramp is preferably controlled by the feedback signal current, optionally mirrored as described above. More particularly the second voltage ramp is preferably proportional to a difference between a maximum constant current and the feedback signal current. The fixed constant current generator is preferably used to generate the first voltage ramp which therefore preferably has a fixed slope. However, preferably, the feedback signal current is used to impose an initialisation voltage on the ramp generator circuit capacitor, for example using a resistor to convert the current into a voltage. Preferably the initialisation voltage is proportional to a ratio of the feedback signal current to the previously mentioned maximum (constant) current.

In a related aspect the invention provides a switch mode power supply (SMPS) controller for combined pulse width and pulse frequency modulation of a power switching device of said SMPS, the controller comprising: an input to receive a feedback signal responsive to an output voltage of said SMPS; and a pulse generator for driving said power switching device, said pulse generator being configured to generate first and second ramp signals, one rising the other falling, and to output a drive pulse with a first period timed by a duration of said first ramp signal for controlling said power switching device on and with a second period timed by a duration of said second ramp signal for controlling said power switching device off; and wherein said pulse generator is further configured to initiate said first ramp signal at a level responsive to said feedback signal.

Preferably the first (rising) ramp signal rises at a substantially constant rate, that is substantially independent of the feedback signal. However, the second ramp signal, preferably ramps at a rate which is (linearly) dependent upon the feedback signal.

As previously mentioned, in preferred embodiments the pulse generator is implemented in CMOS technology, using current mirrors to generate currents for charging and discharging a capacitor in order to create the first and second ramp signals. However, the skilled person will appreciate that in other embodiments the first and second ramp signals may be generated using digital circuitry.

In embodiments the SMPS controller may even be implemented on a processor using appropriate processor control code.

Thus in other aspects the invention further provides processor control code to implement an SMPS controller as described herein, in particular on a data carrier such as a disc, CD-ROM or DVD-ROM programmed memory such as read-only memory or on a data carrier such as an optical or electrical signal carrier. Code and/or data to implement embodiments of a controller as described may comprise source, object or executable code in a conventional programming language (interpreted or compiled) such as C or assembly code, code for setting up or controlling an FPGA (Field Programmable Gate Array) or ASIC, or code for a hardware description language such as Varilog™.

As previously mentioned, however, the SMPS control techniques described herein are particularly suitable for implementation using analogue CMOS technology.

Thus in a further aspect, the invention provides switch mode power supply (SMPS) controller circuit for generating a rising and falling voltage ramp for controlling the timing of switching of a power switching device of said SMPS, the circuit comprising: a current input for a feedback signal current; a first current mirror circuit having an input coupled to said current input and having first and second first current mirror outputs; a constant current generator to generate a substantially constant current; a second current mirror circuit having an input coupled to said substantially constant current generator and having first, second and third constant current outputs; a resistor coupled to said first output of said first current mirror and to said first output of said second current mirror to provide an initialisation voltage; a junction coupled to said second output of said first current mirror and to said second output of said second current mirror to form a difference current, said difference current being dependent upon a difference between said constant current and said feedback signal current; a capacitor; and switches to selectively couple said capacitor to said initialisation voltage, to said third constant current output of said second current mirror to charge said capacitor, and to a supply of said difference current to discharge said capacitor, to generate said rising and falling voltage ramps.

Preferably the SMPS circuit further comprises a comparator coupled to the capacitor to convert the rising and falling voltage ramp to a logic signal. The SMPS circuit then preferably further comprises control logic, responsive to this logic signal to control the switches to initialise the capacitor to the initialisation voltage, to charge the capacitor, and to discharge the capacitor. Thus, broadly speaking, the SMPS preferably includes a switch controller to control the switches to first initialise the rising voltage ramp and then to control the charging and discharging of the capacitor to generate the rising and falling voltage ramps. Preferably the circuit is substantially entirely implemented using MOS technology.

In a still further aspect, the invention provides method of controlling a switch mode power supply (SMPS), the method comprising: initialising a voltage on a capacitor responsive to a feedback signal current dependent upon an output voltage of said SMPS; charging said capacitor at a substantially constant rate to determine an on period for a power switching device of said SMPS; and discharging said capacitor at a rate dependent upon said feedback signal current to determine an off period for said power switching device of said SMPS.

In certain embodiments, the invention also provides a switch mode power supply incorporating an SMPS controller according to each of the aspects of the invention described above; and a switch mode power supply comprising means for implementing the above-described SMPS controlling method.

Slope Compensation

According to a further aspect of the invention there is provided a PWM and PFM SMPS controller for controlling a power switching device of said SMPS, the controller comprising: a first input to received a feedback signal from an output of said SMPS; a second input to receive a current sense signal sensing a current through said switching device; a first ramp generator coupled to said first input to generate a first ramp for controlling a switching frequency of said switching device responsive to said feedback signal; and a second ramp generator coupled to said second input to generate a second ramp for controlling an on time of said switching device responsive to said current sense signal.

Preferably the first ramp generator generates a first sawtooth wave and the controller includes a comparator to compare this with a reference to determine a period of a complete switching cycle of the SMPS, thereby controlling the switching frequency. Preferably the slope of the first sawtooth wave is controlled in response to the feedback signal, which preferably comprises a signal sensing an output current of the SMPS, for example either by primary side sensing (as described in other co-pending applications of the applicant, for example GB0613484.5, GB0613493.6 both filed on 7 Jul. 2006, and GB0610210.7 filed on 23 May 2006, all hereby incorporated by reference in their entirety) or via second side sensing, for example via an opto-isolator.

In some preferred embodiments a limiter is coupled between the first input and the first ramp generator to limit one or both of a maximum and minimum slope of the first ramp to thereby limit one or both of a maximum and minimum value of the switching frequency. In this way, for example, the lower frequency may be limited so that it is above audio range, for example greater than 5 KHz, 10 KHz, 15 KHz or 20 KHz.

In preferred embodiments the second ramp generator is configured to generate a second sawtooth wave signal and the controller includes a further comparator to compare this with a second reference to determine the on (conducting) time of the switching device. Preferably the second reference is also responsive to the feedback signal which preferably comprises a current feedback signal, whereby the controller is current-controlled.

In certain embodiments, the invention further provides a PWM and PFM SMPS controller for controlling a power switching device of said SMPS, the controller comprising: a first input to received a feedback signal from an output of said SMPS; a second input to receive a current sense signal sensing a current through said switching device; a first ramp generator responsive to at least one of said feedback signal and said current sense signal for controlling one or both of a pulse width and pulse frequency of a control signal to said power switching device; a slope compensation ramp generator to generate a compensation ramp for waveform modulating said pulse width of said switching device; and wherein said compensation ramp waveform is responsive to said current sense signal.

Preferably the controller includes an adder/subtracter to add or subtract a signal derived from the current sense signal to the compensation ramp waveform.

In certain embodiments, the invention further provides a PWM and PFM SMPS controller for controlling a power switching device of said SMPS, the controller comprising: a first input to received a feedback signal from an output of said SMPS; a second input to receive a current sense signal sensing a current through said switching device; and a control system to provide a pulse width and frequency modulation control signal to said switching device responsive to both said feedback signal and said current sense signal.

In some particularly preferred embodiments the SMPS controller control system automatically selects two or more of a discontinuous conduction mode (DCM), continuous conduction mode (CCM), and critical conduction mode (CRM) in response to one or both of the feedback signal and the current sense signal.

Some preferred embodiments of an SMPS controller circuit according to any of the above aspects of the invention may be implemented substantially entirely in analogue circuitry and/or substantially entirely in CMOS circuitry.

In a further aspect the invention provides a current limiting current translation circuit, the circuit being configured to receive an input current and to translate said input current to an output current substantially linearly dependent on said input current, one or both of a maximum and minimum value of said output current being limited at one or both of a maximum and minimum limiting current value of said input current, one or both of said maximum and minimum said limiting current values being dependent on a reference current, the circuit comprising: a first input for said input current; a second input for said reference current; at least one current mirror connected to form an intermediate current, said intermediate current having a value of substantially zero at one or both of said maximum and minimum limiting current values; and an output node coupled to an output of said at least one current mirror.

In embodiments the intermediate current has a value of substantially zero at both the maximum and minimum limiting current values of the input current, thereby limiting the output current between corresponding maximum and minimum values. In embodiments the intermediate current has the form K×IREF−(IFB−IREF) where K is a positive constant, IFB is the input current and IREF is the reference current. The constant K may be implemented using transistors of size ratios 1:K in a current mirror. In some preferred embodiments the output node sums the intermediate current and the current dependent upon the reference current (for example (1−K)IFB) to provide the output current. Preferably an output current mirror is coupled to the output node.

In some preferred embodiments a difference current IFB−IREF is formed by coupling one of the input and reference currents to the input of a current mirror and the other to the output of a current mirror; this difference current may then be used to generate the intermediate current, for example using a further current mirror with an input coupled to the reference current (or a mirrored version thereof) and an output scaled by constant K.

In a further aspect the invention provides an addition/subtraction circuit, in particular to subtract the current sense signal from a ramp voltage. Such a circuit may comprise four transistors, two connected as a current mirror, a first further transistor being coupled to an input of the current mirror and being driven by the voltage ramp signal, a second further transistor being coupled to an output of the current mirror. The first and second further transistors may further be coupled to first and second nodes which are selectively coupled to either the current sense signal or to a ground connection so that when one is connected to the current sense signal the other is connected to ground, and vice-versa. The selective coupling may be performed in response to a slope of the current sense signal (using a slope detect circuit) and may be implemented by switching devices.

The skilled person will recognise that embodiments of the above-described SMPS controllers and methods may be employed in a wide variety of application architectures including (but not limited to) a flyback converter, a direct-coupled boost converter and a direct-coupled buck converter. Where the SMPS includes a transformer driven by the power switching device, the feedback signal current may be derived from the secondary side of the transformer (as described in preferred embodiments later) or from the primary side of the transformer, or from an auxiliary winding of the transformer. In SMPS arrangements with an inductor in place of a transformer, the feedback signal may similarly be derived from the primary-side, from the secondary-side, or from an auxiliary winding. The SMPS may operate in either a Discontinuous Conduction Mode (DCM) or in a Continuous Conduction Mode (CCM) or at the boundary of the two (Critical Conduction Mode).

### BRIEF DESCRIPTION OF THE DRAWINGS

These and other aspects of the invention will now be further described, by way of example only, with reference to the accompanying figures in which:

FIG. 1 shows an example of a switch mode power supply (SMPS) incorporating a controller according to an embodiment of the present invention;

FIG. 2 shows a schematic diagram of rising and falling voltage ramps generated by an SMPS controller according to an embodiment of the invention;

FIG. 3 shows a graph of on-time of a power switching device drive signal against a feedback signal current;

FIG. 4 shows a graph of reciprocal off-time of the power switching device drive signal against the feedback signal current;

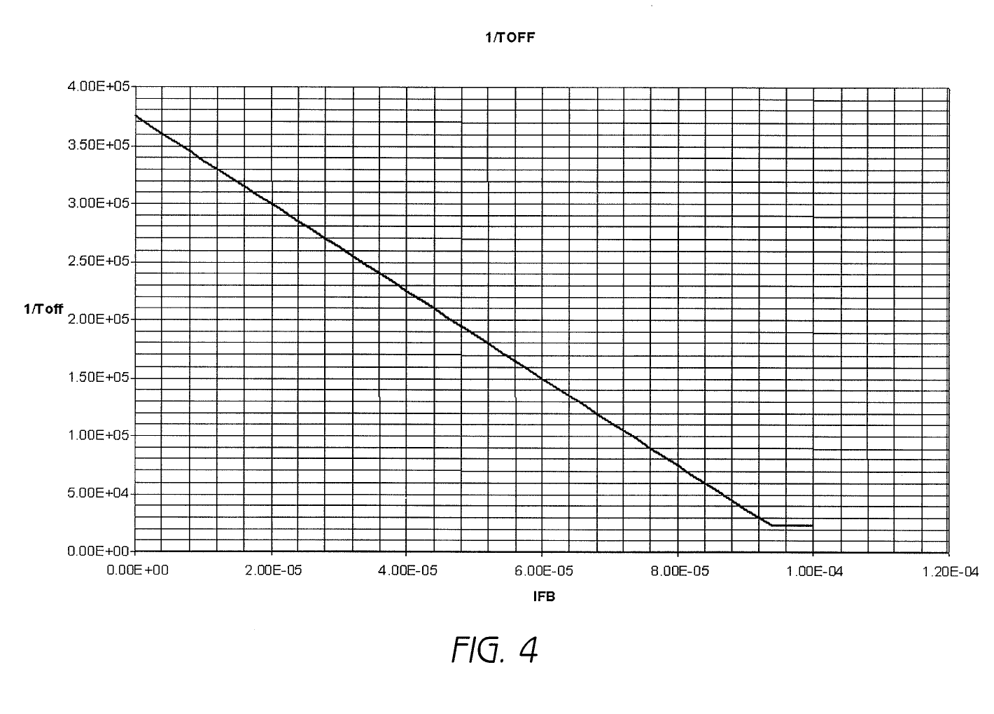

FIG. 5 shows a graph of SMPS switching frequency against feedback signal current;

FIG. 6 shows a graph of relative (percentage) output power against feedback signal current for an SMPS controlled according to an embodiment of the invention;

FIG. 7 shows a graph of SMPS percentage efficiency against load (watts) for an SMPS controlled with an embodiment of the invention;

FIG. 8 shows a block diagram of a PWM/PFM controller according to an embodiment of the invention;

FIG. 9 shows a detailed schematic diagram of an implementation of the PWM/PFM of FIG. 8;

FIG. 10 shows logic circuitry suitable for generating a reset pulse for the controllers of FIGS. 8 and 9;

FIG. 11 shows a schematic diagram of a further embodiment of a PWM/PFM analogue SMPS controller;

FIG. 12 shows example waveforms for the controller of FIG. 11;

FIGS. 13a and 13b show, respectively, a current translator circuit for the controller of FIG. 11, and a transfer function of the circuit of FIG. 13a;

FIG. 14 shows a pulse frequency modulator (PFM) circuit for the controller of FIG. 11;

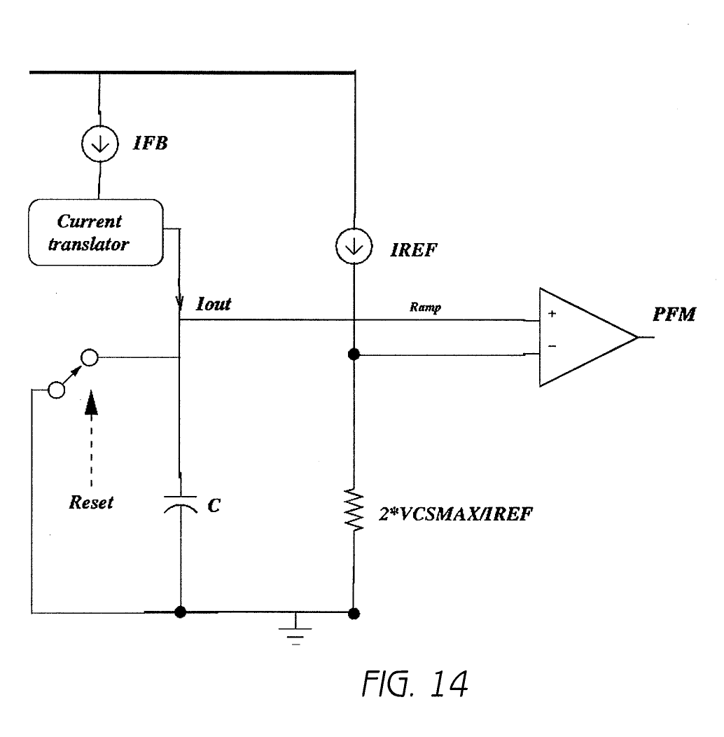

FIG. 15 shows a reset pulse generator for the controller of FIG. 11;

FIG. 16 shows a compensation ramp generator, slope adder and Toff generator for the controller of FIG. 11;

FIG. 17 shows a graph of variation of power switching device on time and SMPS frequency with feedback current for the controller of FIG. 11; and

FIG. 18 shows a graph of variation of relative output power with feedback current for the controller of FIG. 11.

### DETAILED DESCRIPTION OF THE PREFERRED EMBODIMENT

A generalised switch mode power supply (SMPS) comprises an energy transfer device for transferring energy cyclically from an input to an output of the power supply (in a flyback regulator design), a power switching device coupled to the input of the power supply and to the energy transfer device, and a control system for controlling the power switching device. The power switching device has a first state in which energy is stored in the energy transfer device and a second state for transferring the stored energy to the power supply output. Typically the energy transfer device comprises an inductor or transformer and the power switching device is controlled by a series of pulses, the transfer of power between the input and the output of the power supply being regulated by either pulse width modulation and/or pulse frequency modulation.

The control system controls the power switching device in response to a feedback signal to regulate the output voltage of the power supply by regulating the energy transferred per cycle. There are many ways of deriving a feedback signal for the control system to regulate the power supply. Direct feedback from the power supply output may be employed, generally with some form of isolation between the output and input such as an opto-isolator or pulse transformer. Alternatively, if a transformer is used as the energy transfer device, an additional or auxiliary winding on the transformer can be used to sense the reflected secondary voltage, which approximates to the power supply output voltage.

We will describe SMPS controllers which are responsive to a feedback signal current, that is current-controlled circuits.

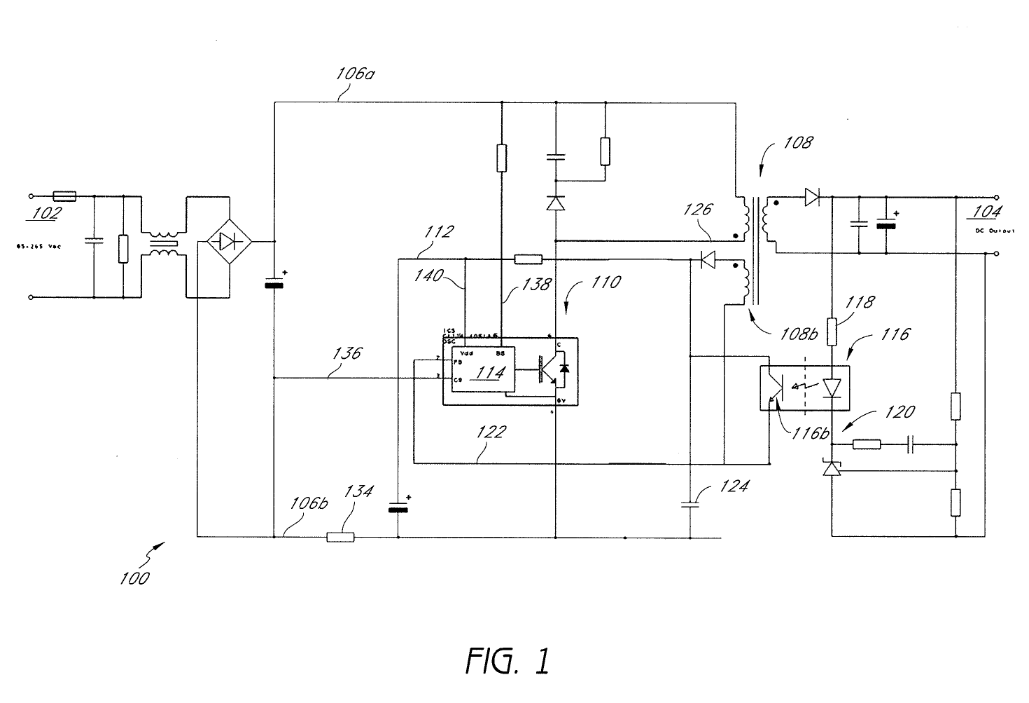

Referring to FIG. 1, this shows a switch mode power supply circuit 100 having a domestic grid mains power supply input 102 and a DC output 104. The mains input 102 is rectified to provide DC power for lines 106a, b which supply power to an energy transfer device, in this example transformer 108 via a switching device, in this example power IGBT (Insulated Gate Bipolar Transistor) 110 (here shown as part of a power supply controller integrated circuit.

An auxiliary winding 108 b provides DC power on line 112 for powering SMPS controller 114, which provides a drive signal to IGBT 110 to switch the device on and off. When the switching device is on energy is stored in the magnetic field of transformer 108, and when the switch turns off this energy is transferred to the secondary side of the transformer, where it is rectified and smoothed to provide DC output 104.

In the illustrated example secondary side feedback is provided by an opto-isolator 116 driven by the DC output voltage via a resistor 118 to a reference voltage circuit 120. Transistor 116b of opto-isolator 116 provides a current feedback signal on line 122 to a feedback input (FB) on controller 114. The SMPS operates in a discontinuous conduction mode in which, when the switching device is turned off, the output voltage after a steady period begins to decline (at which point the transformer begins to ring, entering a so-called oscillatory phase). In the circuit of FIG. 1, when the switching device is on capacitor 124 is charged via diode 126. In the oscillatory phase diode 126 is off and charge is led from capacitor 124 by opto-isolator transistor 116b. The current through the opto-isolator is a function of whether the output voltage is at or below a target on the secondary side, this controlling the rate of descent of the voltage across capacitor 124. The current in feedback line 122 falls at substantially the same rate and thus the current feedback signal on line 122 is substantially proportional to the SMPS output voltage and, furthermore, responds on a power cycle-by-cycle basis.

A resistor 134 in DC supply line 106b acts as a current sense resistor (typically less than 1 ohm) to provide a current sense (CS) input into controller 114 on line 136 (inverted because line 136 is connected to the further end of resistor 134 from controller 114. This signal may be employed in a conventional manner to provide current limiting. Line 138 provides a bootstrap (BS) input to controller 114 which can be used to raise controller VDD rail 140 to its operating voltage level to achieve a rapid start-up.

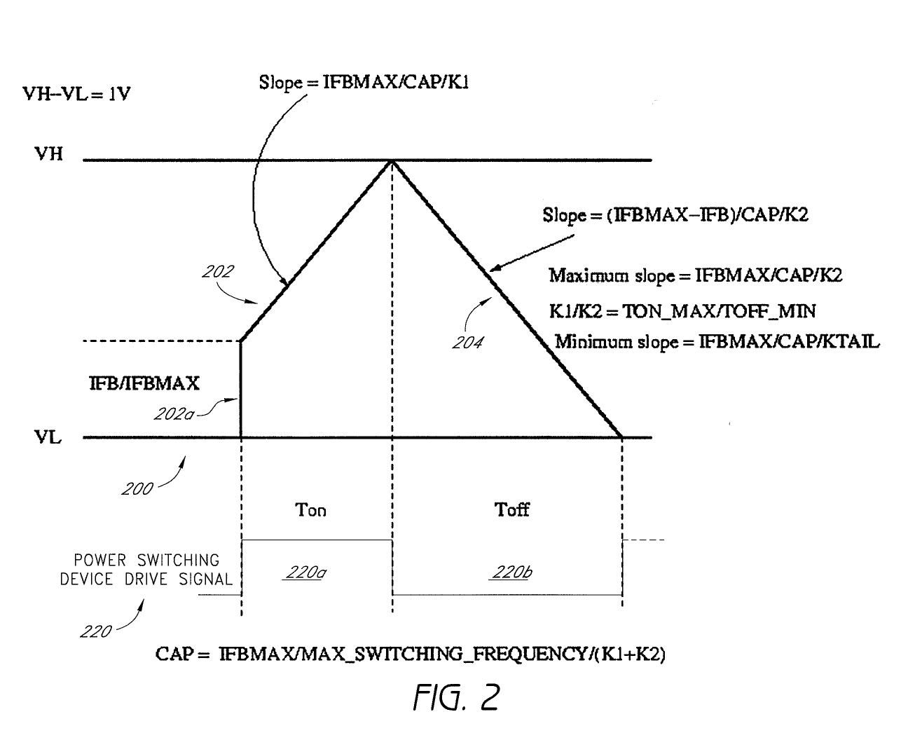

Referring next to FIG. 2, this shows a schematic diagram of a rising and falling voltage ramp 200 generated by an SMPS controller according to an embodiment of the invention, together with a corresponding power switching device drive signal 220 with periods 220a and 220b in which the power switching device is on and off respectively.

The ramp comprises a rising voltage ramp 202 and a falling voltage ramp 204 between lower and upper voltage levels VL and VH respectively (as illustrated 1V apart). The rising voltage ramp 202 has an initial step 202a with a height proportional to IFB/IFBMAX, where IFB is a current feedback signal, for example from an opto-isolator as described above, substantially linearly dependent on the output voltage, and IFBMAX (which is a design parameter) is the feedback (opto-) current which gives a zero on-time. The slope of rising ramp 202 is given by:
Slope=IFBMAX/CAP/K1
The slope of falling ramp 204 is given by:
Slope=(IFBMAX−IFB)/CAP/K2
In the above equations K1 and K2 are scaling factors, chosen such that:
K1/K2=TON_MAX/TOFF_MIN
where TON_MAX and TOFF_MIN are a maximum desired on time and a minimum desired off time respectively. Preferably slope 204 is limited by maximum slope and minimum slope values, in particular as given below:
Maximum Slope=IFBMAX/CAP/K2
Minimum Slope=IFBMAX/CAP/KTAIL
In the above equations CAP is the value of a capacitor which is charged and discharged to generate ramps 202 and 204, as described further below. A value for CAP is given by:
CAP=IFBMAX/MAX_SWITCHING_FREQUENCY/(K1+K2)
where MAX_SWITCHING_FREQUENCY is a maximum desired switching frequency of the power supply.

We next describe details of an example design for a controller with a maximum switching frequency of 125 KHz. However the skilled person will appreciate that the maximum switching frequency may be any practicable value.

To create the ramp of FIG. 2 a capacitor is charged and discharged between the two threshold levels VL and VH by using current sources. The difference between these threshold levels is maintained at 1V. For a different value of (VH−VL) the charging and discharging currents can be scaled to achieve the same frequency. During the on-time, just before the capacitor starts charging up, an initial voltage of magnitude IFB/IFBMAX is placed across the capacitor. Then, a current source charges the capacitor up to the upper threshold level.

The on-time for dependence on opto-current IFS is given by:
Ton=K1*CAP/IFBMAX*[1−IFB/IFBMAX]
Here K1 is a scaling factor proportional to maximum on time. For a system with a maximum switching frequency of 125 KHz, IFBMAX of 100 μA, maximum duty cycle of 66.7% and a capacitance value of 21 pF, K1 is equal to 25.

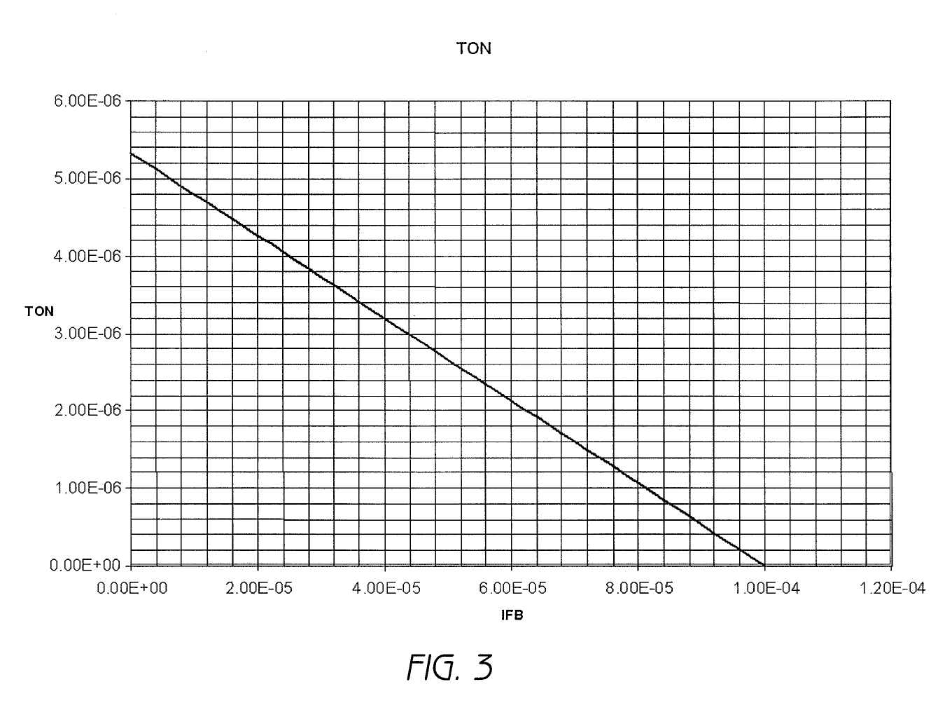

FIG. 3 shows variation of the on time with opto-current IFB for the 125 KHz system described above.

During the off time the capacitor is discharged by a current source. The magnitude of the discharge current is determined by the following logic:
IF(IFB<KTAIL*IFBMAX)
ldischarge=(IFBMAX−IFB)/K2
ELSE
ldischarge=(1−KTAIL)*IFBMAX/K2
where, KTAIL is a constant value that is used to optimise the limiting frequency at low loads. It can be seen that as IFB increases above IFBMAX*KTAIL, the discharge current is limited to not less than a fraction (1=KTAIL) of the maximum, and TOFF is limited to no greater than the value determined by this discharge current.

Therefore:
IF(IFB<KTAIL*IFBMAX)
1/TOFF=(IFBMAX−IFB)/K2/CAP
ELSE
1/TOFF=(1−KTAIL)*IFBMAX/K2/CAP
For a 125 KHz, system mentioned above example values are K2=12.5 and KTAIL= 15/16.

As shown in FIG. 3 the 1/TOFF varies linearly with opto (feedback)-current until the opto-current is 15/16^{th} of IFBMAX. After that the off time remains constant. This allows the frequency to be limited to any value (in the above specific case of a 125 KHz controller, limited to above 20 KHz), thus reducing the audio noise and ripple at light loads. The magnitude of the limit on the discharge ( 1/16 * IFBMAX for a 125 KHz controller) current varies with the maximum switching frequency.

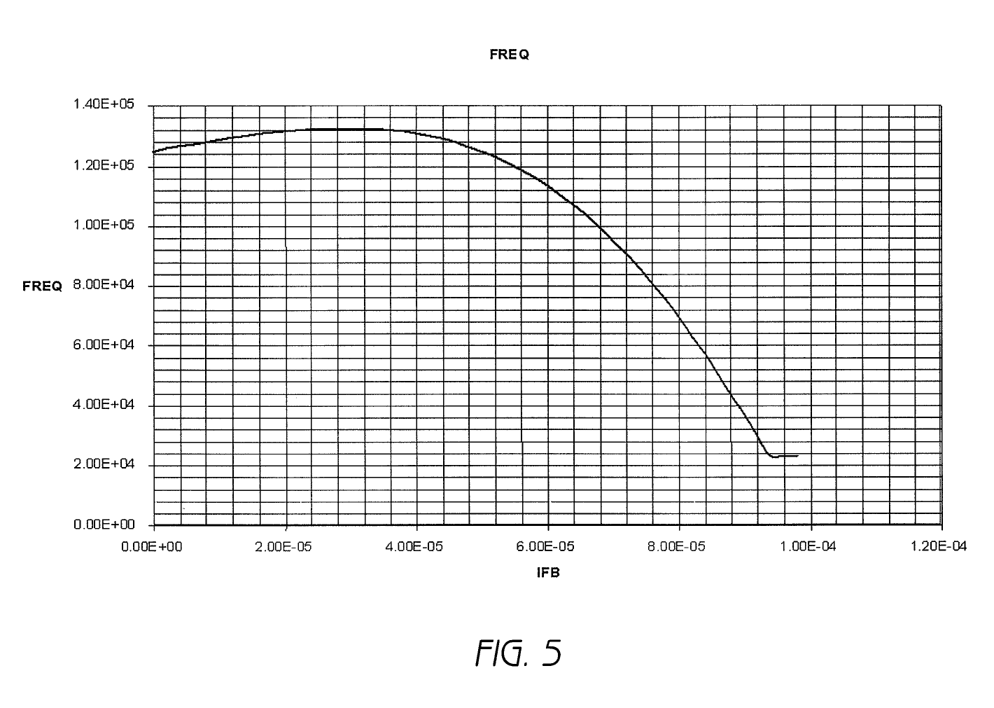

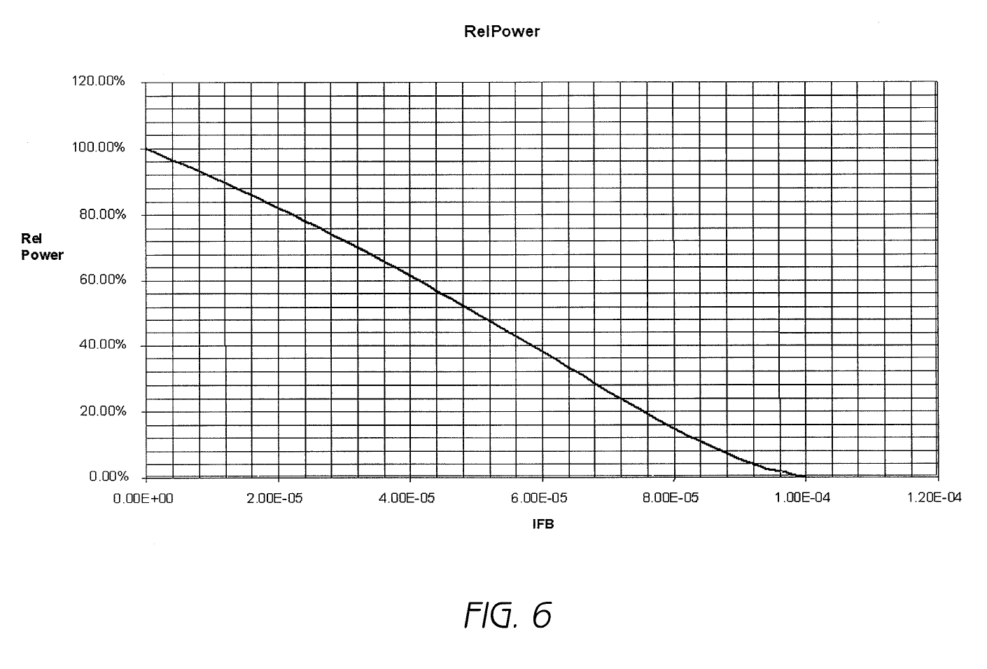

FIG. 5 shows a graph of switching frequency (in Hertz) against opto (feedback) current IFB for the example controller described above, and FIG. 6 shows relative power against IFB, the relative power being expressed as a percentage with 100 percent representing the relative power at zero opto (feedback) current.

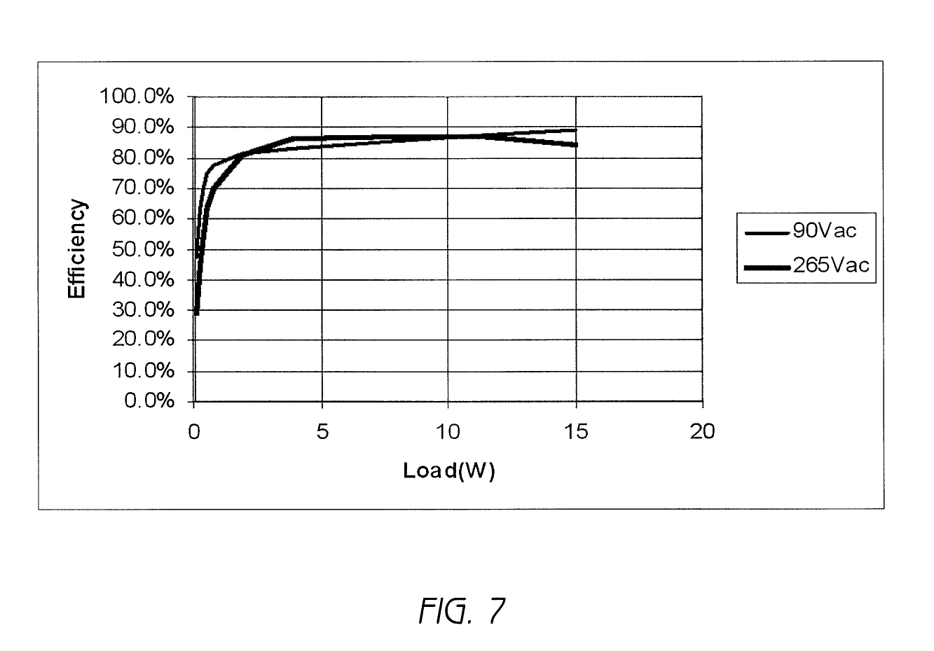

FIG. 7 shows a graph of percentage efficiency of a 15 watt switch mode power supply using the example controller described above, against load (in watts) for a minimum design mains voltage of 90V AC (line 700) and a maximum design mains voltage of 265V AC (line 702).

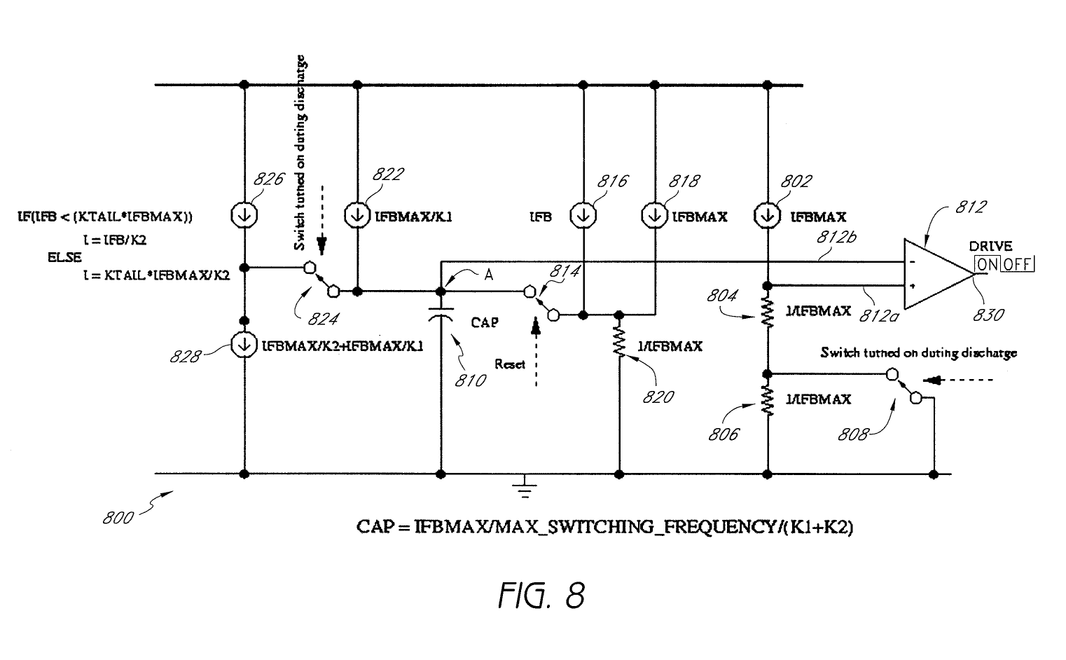

Referring to FIG. 8, this shows a block diagram of a PWM/PFM controller 800 configured to implement the above-described control scheme.

Referring to FIG. 8 a first current generator 802 generates a current IFBMAX which flows through resistor 804 and resistor 806, each of value 1/IFBMAX during charging of capacitor 810; during discharge of capacitor 810 switch 808 is closed and the current only flows through resistor 804. Thus a voltage of either 2V or 1V (depending upon whether switch 808 is open or closed) is present on a first in put 812a of a comparator 812. The second input 812b of comparator 812 is coupled to the “active” side of capacitor 810.

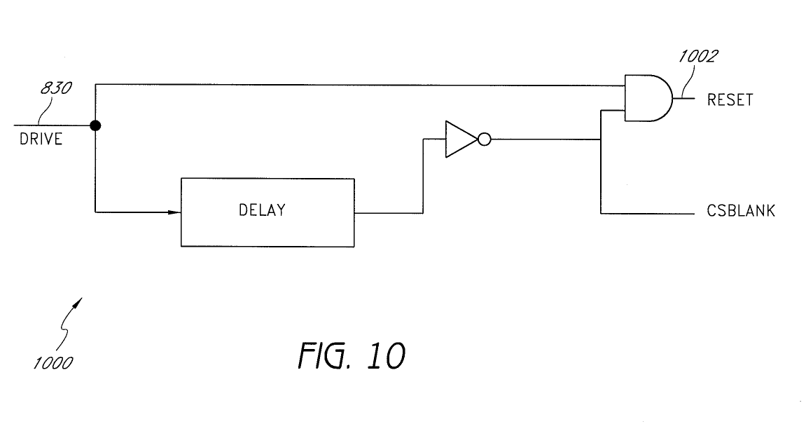

Switch 814 is momentarily closed by a reset signal (the generation of this signal is described below with reference to FIG. 10) at the start of a switching cycle to apply an initialisation voltage to capacitor 810. The magnitude of the initialisation voltage is determined by the combined currents from constant current generator 816 (IFB) and constant current generator 818 (IFBMAX) flowing through resistor 820 (value 1/IFBMAX) and thus has a magnitude IFB/IFMAX in excess of VL (1V).

During the on period of the switching cycle capacitor 810 is charged by constant current generator 822 of value IFBMAX/K1, and switch 824 is open. During discharge of capacitor 810 switch 824 is closed and capacitor 810 is discharged by a current given by the application of Kirchoff's Current Law to the active end of capacitor 810 (node A). This current is therefore determined by the currents generated by constant current generator 826 and constant current generator 828.

The value of constant current generator 826 is determined as follows:
IF(IFB<KTAIL*IFBMAX))
I+IFB/K2
ELSE
I=KTAIL(*IFBMAX/K2
The value of constant current generator 828 is given by:
IFBMAX/K2+IFBMAX/K1

And the value of capacitor 810 is given by:
CAP=IFBMAX/MAX_SWITCHING_FREQUENCY/(K1+K2)
Comparator 812 converts the rising and falling ramps illustrated in FIG. 2 into the power switching device drive signal also illustrated in FIG. 2 to provide 830. Since switches 808 and 824 are turned off during charging of capacitor 810 and on during discharge of capacitor 810 they may be controlled essentially directly by the drive signal waveform at output 830.

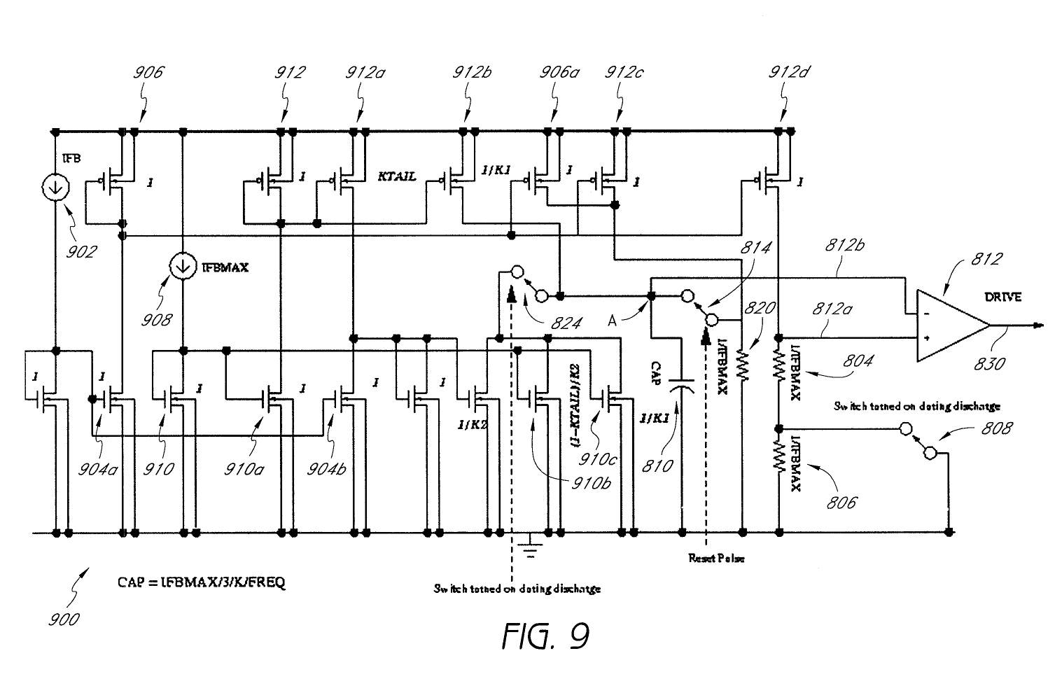

Referring next to FIG. 9, this shows an example implementation of a controller 900 of the block diagram of FIG. 8 in CMOS. In FIG. 9 like elements to those of FIG. 8 are indicated by like reference numerals. However the skilled person will recognise that rather than multiple constant current generators for IFB and IFBMAX, these currents are mirrored. It will further be appreciated that although IFB is shown as a constant current generator, in practice this current is supplied by feedback, for example from an opto-isolator as shown in FIG. 1. To facilitate understanding of the controller 900 a number of currents have been marked. The annotations by the side of the transistors define the (relative) sizes of the transistors. An input current IFB 902 provides an input to a current mirror 904 with output transistors 904a, b. Transistor 904a provides an input current IFB to a further current mirror 906 with an output transistor 906a. A constant current generator 908 provides an input to a second current mirror 910 with output transistors 910a, b, c. Output transistor 910a provides a current IFBMAX which provides an input to current mirror 912 with output transistor 912a, b, c, d. The output currents are in proportion to the sizes of various output transistors. The capacitor has a value given by:
CAP=IFBMAX/3/K/FREQ
Broadly speaking, IFB is mirrored to form, in combination with mirrored IFBMAX, an initialisation voltage for capacitor 810, and is also mirrored to form part of a discharge current for capacitor 810. Current IFBMAX is mirrored to (in combination with IFB) provide an initialisation voltage for capacitor 810, and is mirrored (and scaled) to provide a charge current for capacitor 810, and is also mirrored to provide part of the discharge current for capacitor 810.

FIG. 10 shows a circuit 1000f for generating a brief reset pulse on output 1002. This is used to control switch 814 in FIGS. 8 and 9 to reset the capacitor voltage during each charging phase, as illustrated in FIG. 2.

Broadly speaking we have described analogue PWM/PFM signal generating schemes in which, in preferred embodiments, the on time and off time of the PWM signal are changed simultaneously. The PWM signal has a short off time and low frequency in stand-by operation and high frequency and a long on time with heavy loads. The maximum duty cycle at full load can also be limited, and the minimum frequency of operation can therefore be limited, in particular to above the audio frequency range. Thus embodiments of the controller we describe substantially eliminate audio noise, reduce ripple, and provide low stand-by power loss and low noise under light load conditions. The PWM/PFM circuits we describe are current controlled circuits, in preferred embodiments with a substantially constant charging current and a charging period which is changed by a step change in the capacitor voltage.

In preferred embodiments discharge current limiting logic is used to limit the switching frequency to above (human) audio frequencies. The rate of discharge is changed by subtracting the feedback current from a maximum discharge current. Some particularly preferred embodiments are fully implemented in CMOS.

Slope Compensation

We now describe some additional embodiments of aspects of the invention in which slope compensation is added to reduce or substantially eliminate sub-harmonic oscillations in discontinuous mode and to facilitate achieving control loop stability in continuous conduction mode applications. Preferred implementations employ a fully analogue design which uses PWM/PFM regulation, in particular cycle-by-cycle, to facilitate a fast response to line and load changes.

Referring to FIG. 1, this shows a schematic diagram of a combined pulse width and pulse frequency modulation SMPS controller with cycle-by-cycle current mode regulation.

The frequency of the signal is changed in relation to the magnitude of the feedback current, IFB. The PWM/PFM signal has a short on time and low frequency in the standby operation and high frequency and a long on time at heavy loads. Also the minimum frequency of operation is limited above the audio frequency range. Hence this scheme substantially eliminates audio noise, reduces ripple and has relatively low standby power loss. Also, cycle-by-cycle current mode regulation ensures fast response to line and load changes. The controller runs in both discontinuous (DCM) and continuous (CCM) modes, switching between the two modes as the power demand changes. CCM mode gives generally better overall system efficiency and is preferred for higher power applications.

As described further below, embodiments of the controller are current-controlled. The PFM block uses an apparatus for current translation and limiting that determines the maximum and minimum frequency of operation and the variation of frequency with feedback current. We will also describe apparatus for analogue addition and/or subtraction, suitable for slope compensation. Some preferred embodiments of the controller are fully implemented in CMOS. In embodiments cycle-by-cycle current mode regulations help to ensure a fast response of the PWM/PFM controller.

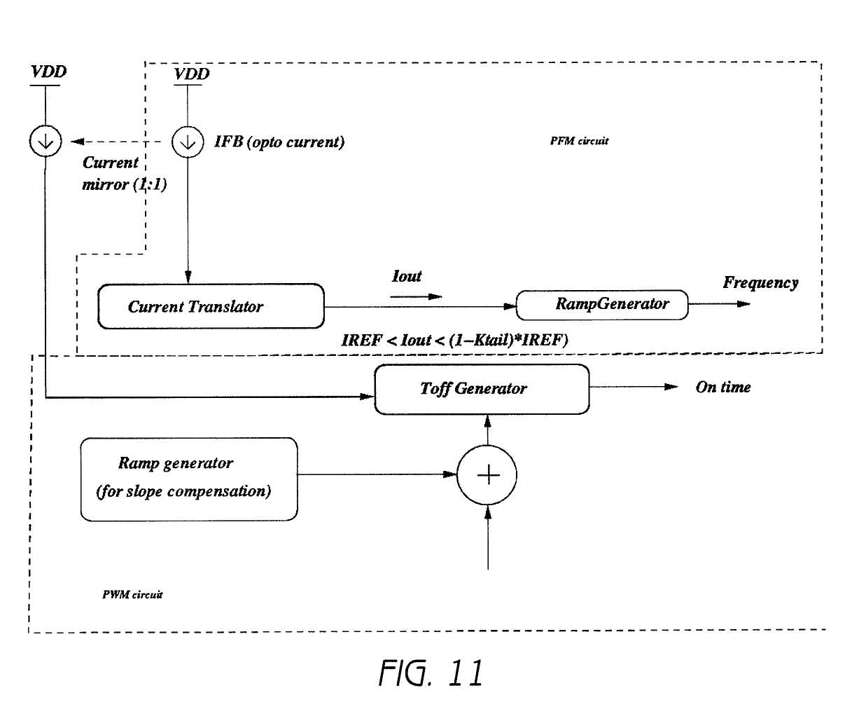

Continuing to refer to FIG. 11, the PFM generator comprises a ramp generator. The period of the ramp is controlled by a current translator circuit described later.

The ramp is started immediately after power switch is turned on. The “Toff” generator switches off the power switch. The on time depends on the amount of feedback opto-current. The higher the opto-current (IFB), lower the on time and vice versa. The input voltage, VCS is derived from a voltage on a current sense input (or IC PIN); this voltage is proportional to the current flowing through the power device.

As soon as the period has lapsed, the period being determined by the feedback opto-current, the power switch is turned on again. Higher the opto-current, lower the frequency of operation and vice-versa.

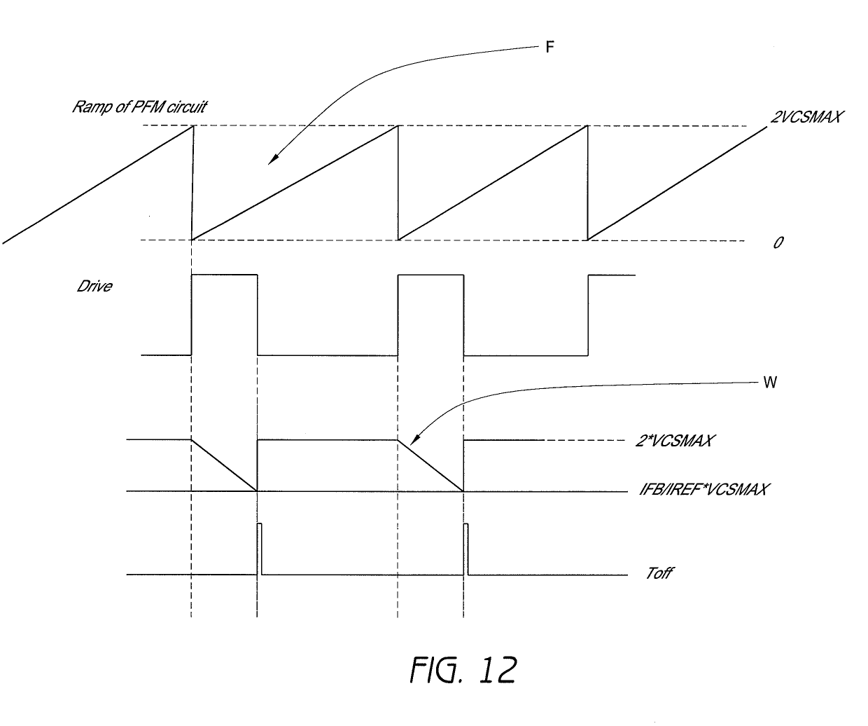

The current translator ensures that the frequency is clamped at a maximum value when opto-current is reduced below a minimum value. It also clamps the frequency at a minimum value when the opto-current increases above a maximum value. Typical waveforms are as shown in FIG. 12. In this figure, VCSMAX is the voltage proportional to maximum current of the power switch. This maximum current flows through the power switch at the lowest mains and the maximum on time (TonMax). The slope of the ramp (F) of the PFM circuit is controlled by the current translator; the slope of the ramp (W) determining the power switching device on time, Ton, is determined by 2* VCSMAX−Vramp−VCS.

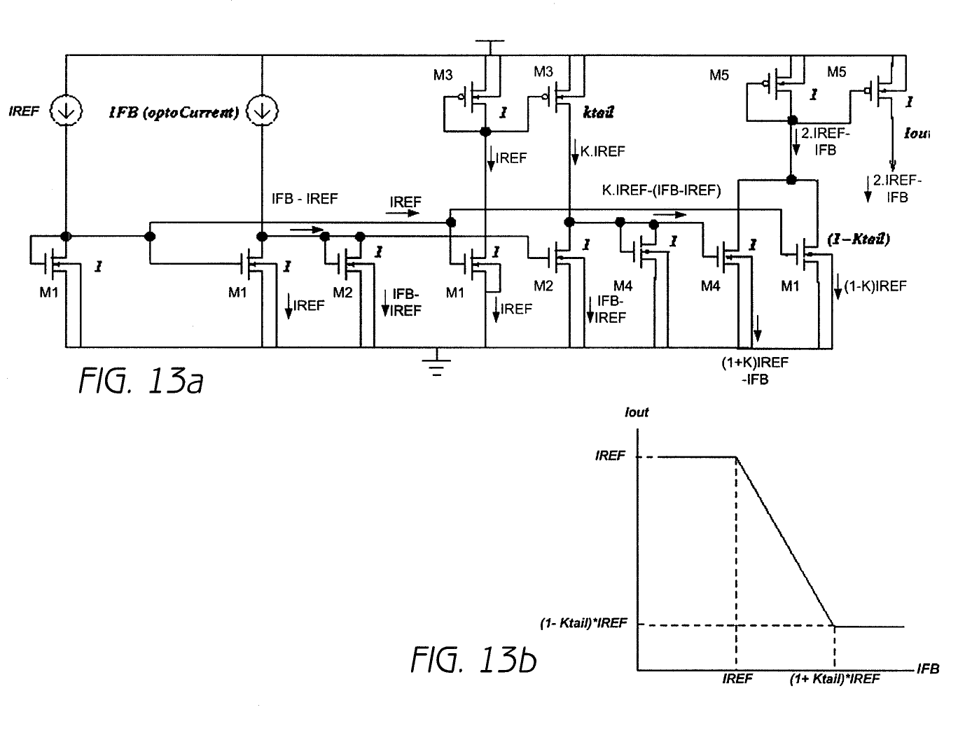

The implementation of an embodiment of the current translator circuit is as shown in FIG. 13a.

Here Ktail is a constant that determines the minimum frequency of operation. The circuit has an output current determined as shown below:
case (IFB<IREF)
Iout=IREF
case (IREF<IFB<(IREF+Ktail*IREF))
Iout=2* IREF−IFB
case (IFB>(I+Ktail)*IREF
Iout=(I−Ktail)*IREF)
The input to the current translation circuit is the opto-current (IFB). The operating range of opto-current is determined by the reference current source “IREF”. The current translator acts both as a current limiter and a current translator. The magnitude of the output current is determined by the logical expression as shown above; intermediate currents are as shown, and current mirrors are indicated by M1, M2 and so forth. The output current limits when either K. IREF−(IFB−IREF)=0 or when IFB−IREF=0. The transfer characteristic is shown in FIG. 13b.

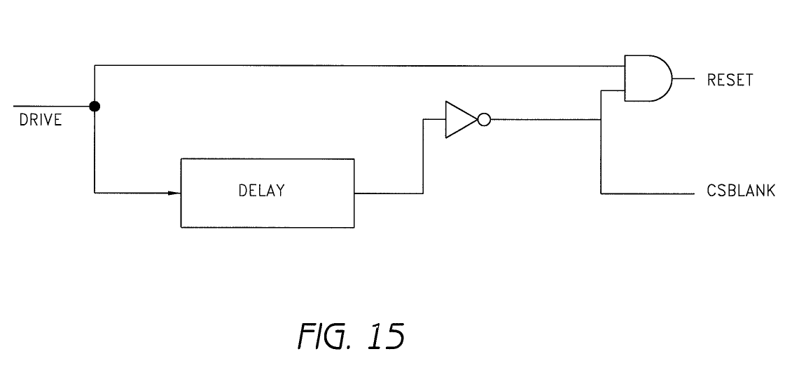

As shown in FIG. 12 as soon as the drive signal goes high the ramp is reset. The capacitor is charged up linearly by the current coming from the current translator circuit. When the ramp voltage reaches the threshold voltage the drive is turned back on and the ramp is reset. A circuit for resetting the ramp is shown in FIG. 15: When the output goes high the switch is closed for a short period of time thus resetting the ramp.

The frequency of the ramp is given by:
Case 1: (IFB<IREF); where IFB is the opto-current and IREF is a constant current source.
The maximum frequency;

$$f max = \frac{IREF}{( 2 * C * VCSMAX )}$$

where VCSMAX is the voltage at the CS pin corresponding to maximum current in the power switch. The frequency (f)=Fmax*(1−Iout/IREF).
Case 2: (IREF<IFB<(1+Ktail )*IREF; where “Ktail” is a constant that is less than 1 that determines the minimum frequency of the controller.
   Frequency=fmax*(1−(IFB−IREF)/IREF)
Case 3: IFB>(1+Ktail)*IREF
   Frequency=fmin=fmax*(1−Ktail)

By adjusting the sizes (“Ktail” and “(1−Ktail)”) of the transistors (refer to FIG. 13) in the current translator circuit we can change the minimum operating frequency. The maximum operating frequency can be changed by changing the size of the capacitor “C” in the PFM circuit. The operating current range can be varied by varying the magnitude of the current source “IREF”.

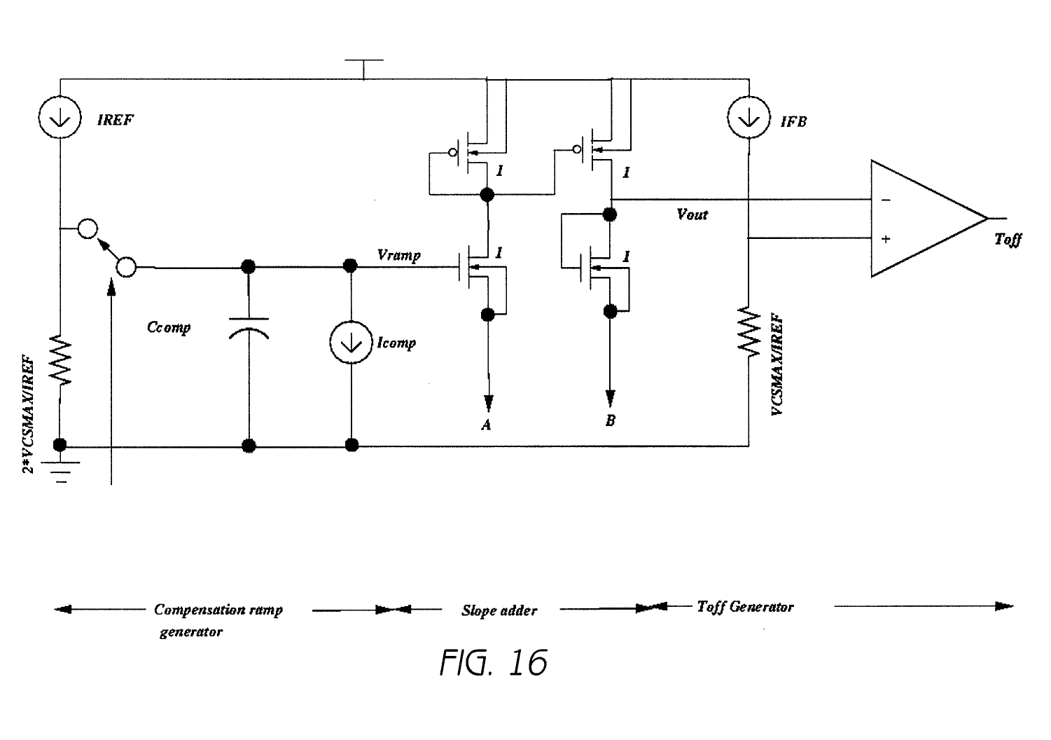

Referring to FIG. 16, this shows a compensation ramp generator, a slope adder and a Toff generator. A compensation ramp is generated internally. The slope of the ramp is controlled by a current source I_{comp} and a capacitor C_{comp}. When the drive signal is turned off the switch shown in FIG. 16 is opened. The switch is open when the drive is on and closed when the drive is off. The capacitor voltage starts decreasing linearly and the slope is given by dv/dt=I_{comp}/C_{comp}. I_{comp} and C_{comp} are chosen to meet the desired value of slope compensation (i.e any dv/dt).

On an integrated circuit embodiment a CS (current sense) pin provides an input for VCS (sensing a voltage through the power switching device via a current sense resistor).

If CS pin is positive going: point A is connected to CS pin, point B is connected to ground, Vout=Vramp−VCS.

If CS pin is negative going: point A is connected to ground, point B is connected to CS pin, Vout=Vramp+VCS

An addition/subtraction circuit comprising four transistors adds or subtracts the VCS (i.e. the voltage on the current sense pin) to or from the ramp voltage. A double pole double throw witch (not shown) has poles connected to ‘A’ and ‘B’ each pole being selectably connected to either VCS or ground so that either A is connected to VCS and B to ground or vice verse, in response to a slope detector which detects the sign of the slop of VCS. If VCS is applied to the point “A” and the point “B” is grounded (FIG. 16) then
Vout=Vramp−VCS.

Thus if VCS is going positive then the slope of VCS increases the slope of ramp. If VCS is applied to the point “B” and the point “A” is grounded (FIG. 16) then
Vout−Vramp+VCS.

Thus if VCS is going negative then the slope of VCS gets added to the slope of ramp, thus increasing the slope of the ramp signal. Thus either sense of connection increases the slope.

The voltage on the CS pin added with the voltage on the ramp is compared against a voltage equal to VCSMAX*IFB/IREF. When the ramp voltage crosses this threshold the drive is turned off.

The maximum on time can be limited by using another comparator that compares the voltage on the CS pin (VCS) to VCSMAX.

The on time is given by
IF(IFB>2*IREF)
Ton=0
ELSE
Ton=MIN(Tmax, Tmax*(2−IFB/IREF)/1+VCOMPMAX/VCSMAX))
Where VCSMAX is the voltage on the current sense pin at the maximum current limit. VCOMPMAX is the maximum compensation voltage at Tmax, Tmax value being the maximum on time.

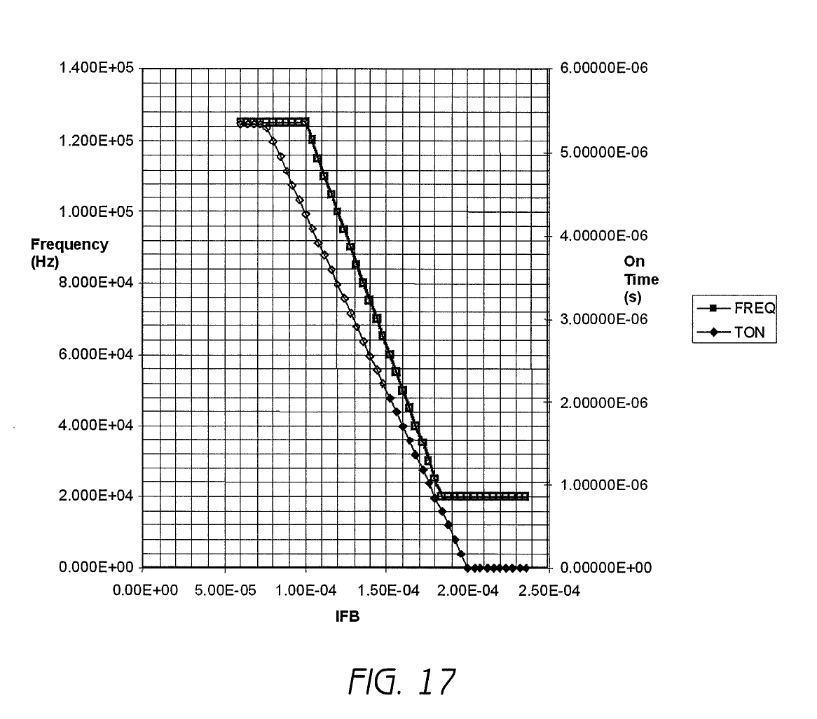

FIG. 17 shows a graph of feedback current on the x-axis (in amps) against frequency on the left hand y-axis in (in hertz) and on time of the power switching device (in seconds) on the right hand y-axis.

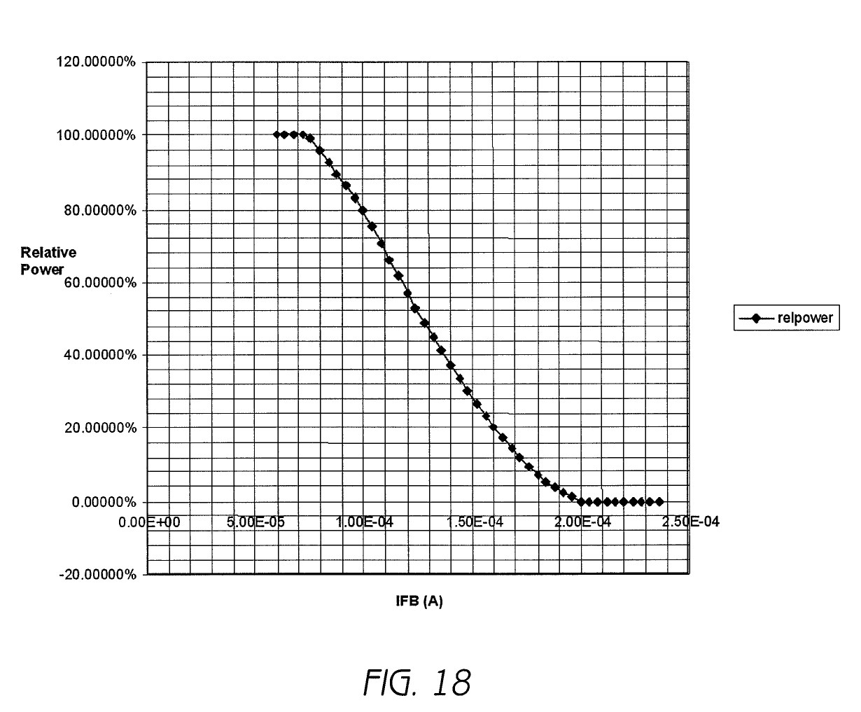

FIG. 18 shows a graph of feedback current (in amps) on the x-axis against relative output power of an SMPS (percentage) on the y-axis. Both FIGS. 17 and 18 refer to a switch mode power supply system with the following parameters: Fmax=125 KHz; Fmin=20 KHz; Tonmax=2/3 of period=5.33 μs; VCSMAX=0.5V; Slope compensation: VCOMPMAX=0.125V=>a dv/dt of 23.45V/ms; Ktail=0.84 for fmin=20 KHz; IREF=100 μA.

Broadly speaking we have described a PWF/PFM circuit which, in embodiments, is fully analogue with cycle-by-cycle current mode regulation that enables a fast response. The circuit is preferably current-controlled, although the skilled person will understand that variations on the above-described embodiment may employ a voltage derived feedback signal, for example comparing the output voltage of an SMPS against a reference. However preferred embodiments vary and limit the frequency of a ramp based upon a feedback current. These preferred embodiments also include a system for current translation and limiting for limiting one or both of the maximum frequency of operation and to limit the lower frequency of operation to above an audio range. Preferred embodiments of the controller also include apparatus implementing an analogue addition and/or subtraction circuit for the above-described slope compensation.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A switch mode power supply (SMPS) controller circuit for controlling a power switching device of said SMPS, the circuit comprising:
a current input to receive a feedback signal current dependent upon an output voltage of said SMPS;
a ramp generator circuit coupled to said current control input to generate responsive to said feedback current signal consecutive first and second voltage ramps, one rising the other falling; and
a control output responsive to said voltage ramps from said voltage ramp generator to provide a drive signal for controlling said power switching device.

2. An SMPS controller circuit as claimed in claim 1 wherein said ramp generator circuit is configured to initialise said first voltage ramp at a voltage level dependent upon said feedback signal current.

3. An SMPS controller circuit as claimed in claim 1 wherein said first voltage ramp has a slope which is substantially independent of said feedback signal current.

4. An SMPS controller circuit as claimed in claim 1 wherein said second voltage ramp has a slope which varies responsive to said feedback signal current.

5. An SMPS controller circuit as claimed in claim 4 further comprising a slope compensation system to adjust a slope of said second voltage ramp responsive to a sensed condition of said SMPS.

6. An SMPS controller circuit as claimed in claim 5 wherein said sensed condition comprises a current through said power switching device.

7. An SMPS controller circuit as claimed in claim 1 wherein a duration of said first voltage ramp determines a duration of a first period of said drive signal for controlling said power switch on, and wherein a duration of said second voltage ramp determines a duration of a second period of said drive signal for controlling said power switch off.

8. An SMPS controller circuit as claimed in claim 7 further comprising a system to limit a slope of second voltage ramp to limit a maximum duration of said second period of said drive signal.

9. An SMPS controller circuit as claimed in claim 8 wherein said maximum duration is no more than 0.1 ms.

10. An SMPS controller circuit as claimed in claim 1 wherein said ramp generator circuit comprises a capacitor and a first substantially fixed constant current generator for one of charging and discharging said capacitor, and a second controllable constant current generator for the other of charging and discharging said capacitor, and wherein said second constant current generator is configured for control by said feedback signal current.

11. An SMPS controller circuit as claimed in claim 10, wherein said second constant current generator is configured to subtract said feedback signal current from a maximum current of said second constant current generator.

12. An SMPS controller circuit as claimed in claim 1 further comprising a comparator coupled between said ramp generator and said output to provide a substantially rectangular said drive signal.

13. An SMPS controller circuit as claimed in claim 1 wherein said first voltage ramp comprises a rising voltage ramp and said second voltage ramp comprises a falling voltage ramp.

14. A switch mode power supply including the SMPS controller circuit of claim 1.

15. A switch mode power supply (SMPS) controller for combined pulse width and pulse frequency modulation of a power switching device of said SMPS, the controller comprising:
an input to receive a feedback signal responsive to an output voltage of said SMPS; and
a pulse generator for driving said power switching device, said pulse generator being configured to generate first and second ramp signals, one rising the other falling, and to output a drive pulse with a first period timed by a duration of said first ramp signal for controlling said power switching device on and with a second period timed by a duration of said second ramp signal for controlling said power switching device off; and
wherein said pulse generator is further configured to initiate said first ramp signal at a level responsive to said feedback signal.

16. An SMPS controller as claimed in claim 15 wherein said first ramp signal has a substantially constant slope with varying output load of said SMPS.

17. An SMPS controller as claimed in claim 15 further comprising a slope compensation system to adjust a slope of said second signal responsive to a current through said power switching device.

18. A switch mode power supply (SMPS) controller circuit for generating a rising and falling voltage ramp for controlling the timing of switching of a power switching device of said SMPS, the circuit comprising:
a current input for a feedback signal current;
a first current mirror circuit having an input coupled to said current input and having first and second first current mirror outputs;
a constant current generator to generate a substantially constant current;
a second current mirror circuit having an input coupled to said substantially constant current generator and having first, second and third constant current outputs;
a resistor coupled to said first output of said first current mirror and to said first output of said second current mirror to provide an initialisation voltage;
a junction coupled to said second output of said first current mirror and to said second output of said second current mirror to form a difference current, said difference current being dependent upon a difference between said constant current and said feedback signal current;
a capacitor; and
switches to selectively couple said capacitor to said initialisation voltage, to said third constant current output of said second current mirror to charge said capacitor, and to a supply of said difference current to discharge said capacitor, to generate said rising and falling voltage ramps.

19. An SMPS circuit as claimed in claim 18 further comprising a comparator coupled to said capacitor to convert said rising and falling voltage ramp to a logic signal on an output of said comparator, to control said switches to charge said capacitor, and then to discharge said capacitor, and control logic responsive to said comparator output to initialise said capacitor to said initialisation voltage.

20. A method of controlling a switch mode power supply (SMPS), the method comprising:
initialising a voltage on a capacitor responsive to a feedback signal current dependent upon an output voltage of said SMPS;
charging said capacitor at a substantially constant rate to determine an on period for a power switching device of said SMPS; and
discharging said capacitor at a rate dependent upon said feedback signal current to determine an off period for said power switching device of said SMPS.

21. A PWM and PFM SMPS controller for controlling a power switching device of said SMPS, the controller comprising:
a first input to received a feedback signal from an output of said SMPS;
a second input to receive a current sense signal sensing a current through said switching device;
a first ramp generator coupled to said first input to generate a first ramp for controlling a switching frequency of said switching device responsive to said feedback signal; and
a second ramp generator coupled to said second input to generate a second ramp for controlling an on time of said switching device responsive to said current sense signal.

22. An SMPS controller as claimed in claim 21 wherein said first ramp generator is configured to generate a first sawtooth wave signal, said controller further comprising a first comparator to compare said first sawtooth wave signal with a first reference to determine a period of a complete switching cycle of said SMPS to control said switching device frequency.

23. An SMPS controller as claimed in claim 22 wherein a slope of said first sawtooth wave is responsive to said feedback signal.

24. An SMPS controller as claimed in claim 23 further comprising a limiter coupled between said first input and said first ramp generator to limit one or both of a maximum and minimum slope of said first ramp to limit one or both of a maximum and minimum value of said switching frequency.

25. An SMPS controller as claimed in of claim 21 wherein said second ramp generator is configured to generate a second sawtooth wave signal, said controller further comprising a second comparator to compare said second sawtooth wave signal with a second reference to determine said on time of said switching device.

26. An SMPS controller as claimed in claim 25 wherein said second reference is responsive to said feedback signal.

27. An SMPS controller as claimed in claim 21 wherein a slope of said second ramp is responsive to a slope of said current sense signal.

28. A PWM and PFM SMPS controller for controlling a power switching device of said SMPS, the controller comprising:
a first input to receive a feedback signal from an output of said SMPS;
a second input to receive a current sense signal sensing a current through said switching device;
a first ramp generator responsive to at least one of said feedback signal and said current sense signal for controlling one or both of a pulse width and pulse frequency of a control signal to said power switching device;
a slope compensation ramp generator to generate a compensation ramp for waveform modulating said pulse width of said switching device; and
wherein said compensation ramp waveform is responsive to said current sense signal.

29. An SMPS comptroller as claimed in claim 28 further comprising an adder/subtracter to add or subtract a signal derived from said current sense signal to said compensation ramp waveform.

30. A PWM and PFM SMPS controller for controlling a power switching device of said SMPS, the controller comprising:
a first input to received a feedback signal from an output of said SMPS;
a second input to receive a current sense signal sensing a current through said switching device; and
a control system to provide a pulse width and frequency modulation control signal to said switching device responsive to both said feedback signal and said current sense signal.

31. An SMPS controller as claimed in claim 30 wherein said control system is configured automatically to select between at least two of a discontinuous conduction mode (DCM), a critical conduction mode (CRM) and a continuous conduction mode (CCM) response to said feedback signal and said current sense signal.

32. An SMPS controller as claimed in claim 21 implemented substantially entirely in analogue circuitry.

33. An SMPS controller as claimed in claim 21 implemented in CMOS circuitry.

34. An SMPS including an SMPS controller as claimed in claim 21.

35. An SMPS including an SMPS controller as claimed in claim 28.

36. An SMPS including an SMPS controller as claimed in claim 30.

37. A current limiting current translation circuit, the circuit being configured to receive an input current and to translate said input current to an output current substantially linearly dependent on said input current, one or both of a maximum and minimum value of said output current being limited at one or both of a maximum and minimum limiting current value of said input current, one or both of said maximum and minimum said limiting current values being dependent on a reference current, the circuit comprising:
a first input for said input current;
a second input for said reference current;
at least one current mirror connected to form an intermediate current, said intermediate current having a value of substantially zero at one or both of said maximum and minimum limiting current values; and
an output node coupled to an output of said at least one current mirror.

38. A current limiting current translation circuit as claimed in claim 37 wherein said intermediate current has a value of substantially zero at both of said maximum and minimum limiting current values.

39. A current limiting current translation circuit as claimed in claim 37 wherein said intermediate current has the form:
K×IREF−(IFB−IREF)
where K is a positive constant, IFB is said input current and IREF is said reference current.

40. A current limiting current translation circuit as claimed in claim 37 wherein said output node is configured to sum said intermediate current and a current dependent on said reference current to provide said output current.
